(19) United States
(12) Patent Application Publication
(10) Pub. No.: US 2024/0380443 A1
(43) Pub. Date: Nov. 14, 2024

(54) METHOD AND APPARATUS FOR MULTIPLE-INPUT AND MULTIPLE-OUTPUT (MIMO) CHANNEL STATE INFORMATION (CSI) FEEDBACK

(71) Applicant: MediaTek Singapore Pte. Ltd., Singapore (SG)

(72) Inventor: Gyu Bum KYUNG, San Jose, CA (US)

(21) Appl. No.: 18/691,116

(22) PCT Filed: Feb. 6, 2023
(86) PCT No.: PCT/US2023/062031

§ 371 Date: Mar. 12, 2024

Related U.S. Application Data
(60) Provisional application No. 63/313,299, filed on Feb. 24, 2022.

(51) Int. Cl. H04B 7/0417; H04L 25/02; H04W 24/10

(52) U.S. Cl. CPC H04B 7/0417; H04L 25/0204; H04W 24/10

(57) ABSTRACT

This disclosure provides methods for channel state information (CSI) feedback. In one method, at a user equipment (UE), CSI data of a communication channel between the UE and a base station (BS) is collected. The UE is configured with an encoder model to compress CSI and the BS is configured with a decoder model to decompress CSI. Based on the collected CSI data, online training is performed at the UE on a previously trained encoder-decoder model pair including the encoder model and the decoder model to generate updated models for the encoder model and the decoder model, respectively. In another method, the CSI data is collected at the BS and the online training is performed at the BS based on the collected CSI data. In another method, the CSI data is collected at a server and the online training is performed at the server based on the collected CSI data

### INCORPORATION BY REFERENCE

This present disclosure claims the benefit of U.S. Provisional Application No. 63/313,299, filed on Feb. 24, 2022, which is incorporated herein by reference in its entirety.

### TECHNICAL FIELD

The present disclosure relates to wireless communications, and specifically to a procedure for channel state information feedback between a transmitter and a receiver.

### BACKGROUND

In wireless communications, channel state information (CSI) can estimate channel properties of a communication link between a transmitter and a receiver. In related arts, the receiver can estimate the CSI of the communication link and feedback the raw CSI to a transmitter. This procedure can consume a great deal of communication resources and place a tremendous strain on a wireless network using modern multiple-input and multiple-output (MIMO) technology.

### SUMMARY

Aspects of the disclosure provide a method for channel state information (CSI) feedback. Under the method, at a user equipment (UE), CSI data of a communication channel between the UE and a base station (BS) is collected. The UE is configured with an encoder model to compress CSI and the BS is configured with a decoder model to decompress CSI. Based on the collected CSI data, online training is performed at the UE on a previously trained encoder-decoder model pair including the encoder model and the decoder model to generate updated models for the encoder model and the decoder model, respectively.

In an embodiment, the updated model for the decoder model is sent from the UE to the BS. The encoder model is updated at the UE based on the updated model for the encoder model. A CSI element is compressed at the UE based on the updated encoder model of the UE.

In an embodiment, the updated model for the decoder model is received at the BS from the UE. The decoder model of the BS is updated at the BS based on the updated model for the decoder model. A compressed CSI element is decompressed at the BS based on the updated decoder model of the BS.

In an embodiment, the updated models include at least partial parameters of the encoder model and the decoder model.

In an embodiment, a reference signal from the BS is received at the UE. The CSI data is measured at the UE based on the reference signal.

Aspects of the disclosure provide a UE for CSI feedback. The UE includes processing circuitry that collects CSI data of a communication channel between the UE and a BS. The UE is configured with an encoder model to compress CSI and the BS is configured with a decoder model to decompress CSI. Based on the collected CSI data, the processing circuitry of the UE performs online training on a previously trained encoder-decoder model pair including the encoder model and the decoder model to generate updated models for the encoder model and the decoder model, respectively.

In an embodiment, the processing circuitry updates the encoder model of the UE based on the updated model for the encoder model. The processing circuitry compresses a CSI element into a compressed CSI element based on the updated encoder model of the UE. The CSI element and the updated model for the decoder model are sent from the UE to the BS. The updated model for the decoder model received by the BS is used by the BS to update the decoder model of the BS. The compressed CSI element is decompressed by the BS based on the updated decoder model of the BS.

In an embodiment, the updated models include at least partial parameters of the encoder model and the decoder model.

In an embodiment, a reference signal from the BS is received at the UE. The CSI data is measured at the UE based on the reference signal.

Aspects of the disclosure provide a method for CSI feedback. Under the method, at a BS, CSI data of a communication channel between the BS and a UE is collected. The UE is configured with an encoder model to compress CSI and the BS is configured with a decoder model to decompress CSI. Based on the collected CSI data, online training is performed at the BS on a previously trained encoder-decoder model pair including the encoder model and the decoder model to generate updated models for the encoder model and the decoder model, respectively.

In an embodiment, the updated model for the encoder model is sent from the BS to the UE. The decoder model of the BS is updated at the BS based on the updated model for the decoder model. A compressed CSI element is decompressed at the BS based on the updated decoder model of the BS.

In an embodiment, the updated model for the encoder model is received at the UE from the BS. The encoder model of the UE is updated at the UE based on the updated model for the encoder model. A CSI element is compressed at the UE based on the updated encoder model of the UE.

In an embodiment, the updated models include at least partial parameters of the encoder model and the decoder model.

In an embodiment, a reference signal is received at the BS from the UE. The CSI data is measured at the BS based on the reference signal.

In an embodiment, a reference signal is sent from the BS to the UE. A CSI report is received at the BS from the UE. The CSI report includes the CSI data that is generated by the UE based on the reference signal.

Aspects of the disclosure provide a BS for CSI feedback. The BS includes processing circuitry that collects CSI data of a communication channel between a UE and the BS. The UE is configured with an encoder model to compress CSI and the BS is configured with a decoder model to decompress CSI. Based on the collected CSI data, the processing circuitry of the BS performs online training on a previously trained encoder-decoder model pair including the encoder model and the decoder model to generate updated models for the encoder model and the decoder model, respectively.

In an embodiment, the processing circuitry updates the decoder model of the BS based on the updated model for the decoder model. The updated model for the encoder model is sent from the BS to the UE. The updated model for the encoder model received by the UE is used by the UE to update the encoder model of the UE. A CSI element is compressed at the UE into a compressed CSI element based on the updated encoder model of the UE. The compressed CSI element is sent from the UE to the BS. The compressed CSI element received by the BS is decompressed at the BS based on the updated decoder model of the BS.

In an embodiment, the updated models include at least partial parameters of the encoder model and the decoder model.

In an embodiment, a reference signal is received at the BS from the UE. The CSI data is measured at the BS based on the reference signal.

In an embodiment, a reference signal is sent from the BS to the UE. A CSI report is received at the BS from the UE. The CSI report includes the CSI data that is generated by the UE based on the reference signal.

Aspects of the disclosure provide a method for CSI feedback. Under the method, at a server, CSI data of a communication channel between a UE and a BS is collected. The UE is configured with an encoder model to compress CSI and the BS is configured with a decoder model to decompress CSI. Based on the collected CSI data, online training is performed at the server on a previously trained encoder-decoder model pair including the encoder model and the decoder model to generate updated models for the encoder and the decoder, respectively.

In an embodiment, the updated models for the encoder model and the decoder model are sent from the server to the BS. The updated models for the encoder model and the decoder model are received at the BS from the server. The decoder model of the BS is updated at the BS based on the updated model of the decoder model. The updated model for the encoder model is sent from the BS to the UE. The updated model of the encoder model is received at the UE from the BS. The encoder model of the UE is updated at the UE based on the updated model of the encoder model.

In an embodiment, the updated models for the encoder model and the decoder model are sent from the server to the UE. The updated models for the encoder model and the decoder model are received at the UE from the server. The encoder model is updated at the UE based on the updated model of the encoder model. The updated model for the decoder model is sent from the UE to the BS. The updated model for the decoder model is received at the BS from the UE. The decoder model is updated at the BS based on the updated model of the decoder model.

In an embodiment, the updated model for the decoder model is sent from the server to the BS, and the updated model for the encoder model is sent from the server to the UE.

In an embodiment, at the server, the CSI data is collected from at least one of the BS and the UE.

Aspects of the disclosure provide a sever for CSI feedback. The server includes processing circuitry that collects CSI data of a communication channel between a UE and a BS. The UE is configured with an encoder model to compress CSI and the BS is configured with a decoder model to decompress CSI. Based on the collected CSI data, the processing circuitry of the server performs online training on a previously trained encoder-decoder model pair including the encoder model and the decoder model to generate updated models for the encoder model and the decoder model, respectively.

In an embodiment, the updated models for the encoder model and the decoder model are sent from the server to the BS. The updated models for the encoder model and the decoder model are received at the BS from the server. The decoder model of the BS is updated at the BS based on the updated model of the decoder model. The updated model for the encoder model is sent from the BS to the UE. The updated model of the encoder model is received at the UE from the BS. The encoder model of the UE is updated at the UE based on the updated model of the encoder model.

In an embodiment, the updated models for the encoder model and the decoder model are sent from the server to the UE. The updated models for the encoder model and the decoder model are received at the UE from the server. The encoder model is updated at the UE based on the updated model of the encoder model. The updated model for the decoder model is sent from the UE to the BS. The updated model for the decoder model is received at the BS from the UE. The decoder model is updated at the BS based on the updated model of the decoder model.

In an embodiment, the updated model for the decoder model is sent from the server to the BS, and the updated model for the encoder model is sent from the server to the UE.

In an embodiment, at the server, the CSI data is collected from at least one of the BS and the UE.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows an exemplary procedure of CSI feedback according to embodiments of the disclosure;

FIG. 2 shows another exemplary procedure of CSI feedback according to embodiments of the disclosure;

FIGS. 3A-3E show various exemplary procedures of the online training CSI data according to embodiments of the disclosure;

FIGS. 4A-4C show flowcharts outlining various processes according to embodiments of the disclosure;

FIG. 5 shows an exemplary apparatus according to embodiments of the disclosure; and

FIG. 6 shows an exemplary computer system according to embodiments of the disclosure.

### DETAILED DESCRIPTION OF EMBODIMENTS

The detailed description set forth below in connection with the appended drawings is intended as a description of various configurations and is not intended to represent the only configurations in which the concepts described herein may be practiced. The detailed description includes specific details for the purpose of providing an understanding of various concepts. However, these concepts may be practiced without these specific details.

Several aspects of telecommunication systems will now be presented with reference to various apparatuses and methods. These apparatuses and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

In wireless communications, channel state information (CSI) can estimate channel properties of a communication link between a transmitter and a receiver. For example, CSI can describe how a signal propagates from the transmitter to the receiver, and represent a combined effect of phenomena such as scattering, fading, power loss with distance, and the like. Thus, CSI can also be referred to as channel estimation. CSI can make it feasible to adapt the transmission between the transmitter and the receiver to current channel conditions, and thus is a critical piece of information that needs to be shared between the transmitter and the receiver to allow high-quality signal reception.

In an example, the transmitter and the receiver (or transceivers) can rely on CSI to compute their transmit precoding and receive combining matrices, among other important parameters. Without CSI, a wireless link may suffer from a low signal quality and/or a high interference from other wireless links.

To estimate CSI, the transmitter can send a predefined signal to the receiver. That is, the predefined signal is known to both the transmitter and the receiver. The receiver can then apply various algorithms to perform CSI estimation. At this stage, CSI is known to the receiver only. The transmitter can rely on feedback from the receiver for acquiring CSI knowledge.

Raw CSI feedback, however, may require a large overhead which may degrade the overall system performance and cause a large delay. Thus, the raw CSI feedback is typically avoided.

Alternatively, from CSI, the receiver can extract some important or necessary information for the transmitter operations, such as precoding weights, rank indicator (RI), channel quality indicator (CQI), modulational and coding scheme (MCS), and the like. The extracted information can be much smaller than the raw CSI, and the receiver can only feedback these small pieces of information to the transmitter.

To further reduce the overhead, the receiver can estimate the CSI of the communication link and select a best transmit precoder from a predefined codebook of precoders based on the estimated CSI. Further, the receiver can feed information related to the selected best transmit precoder back to the transmitter, such as PMI from such a codebook. This procedure can consume a great deal of communication resources and place a tremendous strain on a wireless network using modern multiple-input and multiple-output (MIMO) technology.

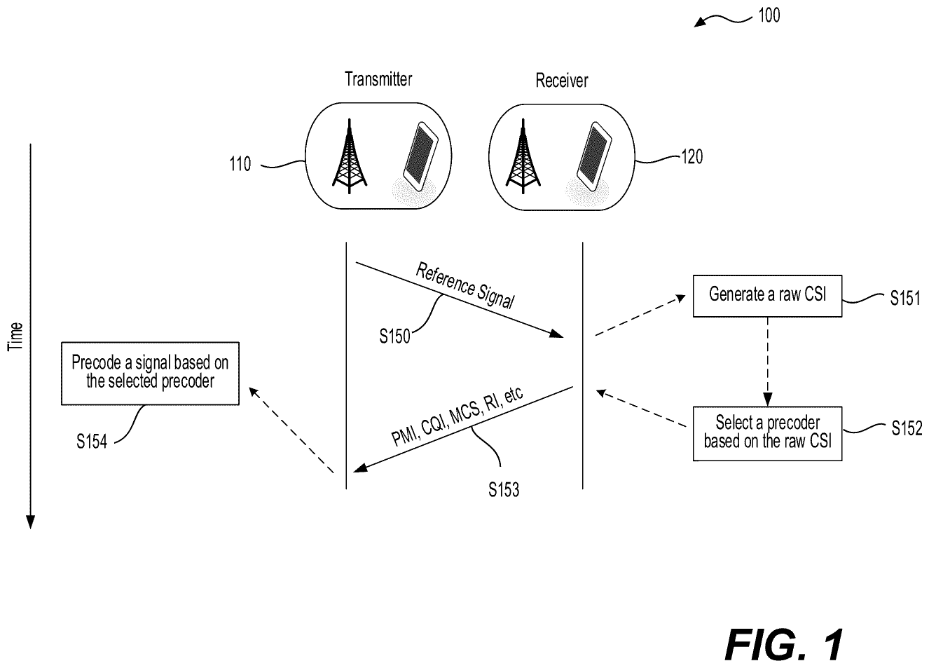

FIG. 1 shows an exemplary procedure 100 of CSI feedback according to embodiments of the disclosure. In the procedure 100, each of a transmitter 110 and a receiver 120 can be a user equipment (UE) or a base station (BS).

At step S150, the transmitter 110 can transmit a reference signal (RS) to the receiver 120. The RS is also known to the receiver 120 before the receiver 120 receives the RS. In an embodiment, the RS can be specifically intended to be used by devices to acquire CSI and thus is referred to as CSI-RS.

At step S151, after receiving the CSI-RS, the receiver 120 can generate a raw CSI by comparing the received CSI-RS with the transmitted CSI-RS that is already known to the receiver 120.

At step S152, the receiver 120 can select a best transmit precoder from a predefined codebook of precoders based on the raw CSI.

At step S153, the receiver 120 can send a PMI of the selected precoder back to the transmitter 110, along with relevant information such as CQI, RI, MCS, and the like.

At step S154, after receiving the PMI and the relevant information, the transmitter 110 can determine transmission parameters and precode a signal based on the selected precoder indicated by the PMI.

It is noted that a choice of the precoders is restricted to the predefined codebook in the procedure 100. However, restricting the choice of the precoders to the predefined codebook can limit the achievable system performance. Different precoder codebooks (e.g., 3GPP NR downlink Type I-Single Panel/Multi-Panel, Type II, eType II, or uplink codebook) have different preset feedback overheads. If the network specifies a preset codebook before the raw CSI is estimated at the receiver, the receiver is not able to further optimize the codebook selection based on tradeoffs between the feedback overhead and the system performance.

Aspects of this disclosure provide methods and embodiments to feedback a compressed version of raw CSI to a transmitter. Based on the compressed CSI, the transmitter is able to optimally compute a precoder for precoding a transmitting signal, and also optimally decide on other transmission parameters such as RI, MCS, and the like. Further, a compression ratio used in compressing the raw CSI can be decided dynamically after the raw CSI has been estimated, in order to allow an optimal tradeoff between the feedback overhead and the system performance.

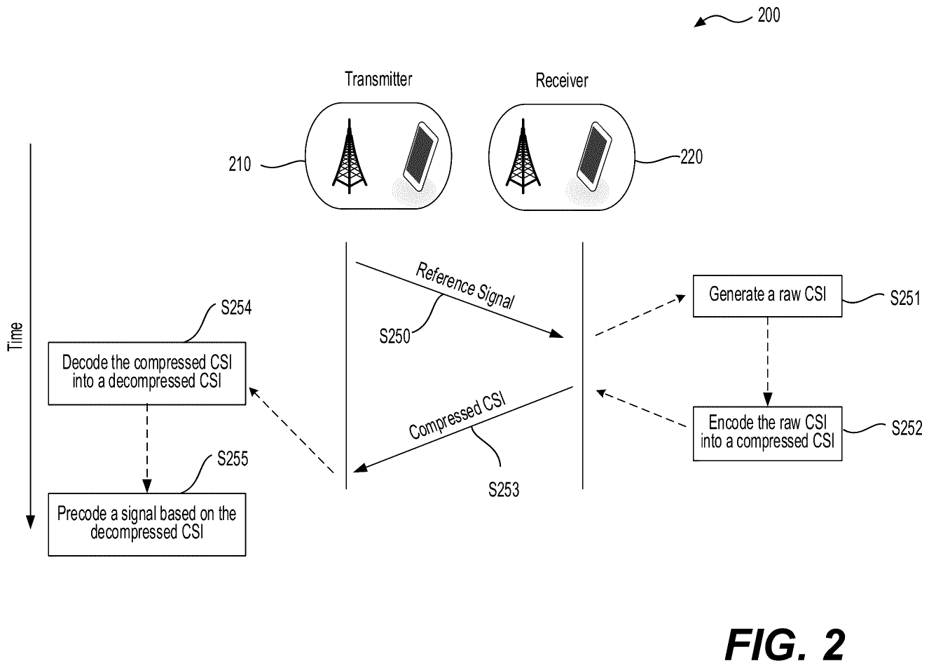

FIG. 2 shows an exemplary procedure 200 of CSI feedback according to embodiments of the disclosure. In the procedure 200, each of a transmitter 210 and a receiver 220 can be a user equipment (UE) or a base station (BS), and steps S250 and S251 are similar to steps S150 and S151 in the procedure 100 of FIG. 1, respectively.

At step S252, the receiver 220 can encode (or compress) the raw CSI into a compressed CSI.

At step S253, the receiver 220 can send the compressed CSI back to the transmitter 210.

At step S254, the transmitter 210 can decode (or decompress) the compressed CSI into a decompressed CSI.

At step S255, the transmitter 210 can determine transmission parameters and precode a signal based on the decompressed CSI.

According to aspects of the disclosure, massive MIMO system can increase DL (downlink) throughput in a wireless system and downlink CSI feedback overhead can be significantly increased due to a large number of antennas at a base station. Accordingly, CSI compression can help to reduce the CSI feedback overhead.

There are various CSI compression algorithms, for example compressive sensing based CSI compression and deep learning (or machine learning) based CSI compression. Compared with the compressive sensing based CSI compression, the deep learning based solution can provide a better reconstruction performance, for example, in terms of mean squared error, at a base station. In an embodiment, an encoder can use a deep neural network at a UE to compress original CSI and a decoder can use a deep neural network at a base station to decompress the compressed CSI and reconstruct the CSI.

In the deep learning (or machine learning) based CSI compression, a CSI matrix can be converted into a multi-dimensional intensity matrix (or a CSI image) which can be considered as a color image. However, compared to the color image used in image processing, the CSI image is relatively simpler. For example, the CSI matrix (or image) may have fewer dimensions or may be sparser than the color image used in the image processing. Accordingly, the deep learning based CSI compression may suffer from an overfitting problem in a trained neural network model. That is, the trained neural network model may only perform well for CSI training data, but shows a relatively worse performance for CSI test data. The trained neural network model can easily find an optimal function to compress the trained CSI image. However, the trained neural network model can only fit well to the trained CSI image and is hard to fit well to a test CSI image.

To overcoming the overfitting problem, various regularization or dropout methods can be used. In addition, online training can be used, in which more data is collected and trained after a trained neural network model is already deployed in the field. Online training can also help to adjust the trained neural network model for a more diverse channel environment.

This disclosure provides methods and embodiments of applying online training to a deep learning (or machine learning) based CSI compression. In the online training, an encoder model (or structure) can be automatically trained together with a decoder model to form an auto trained encoder-decoder model pair. The encoder model and/or the decoder model can be deep learning (or machine learning) based model(s). The encoder model and/or decoder model can be first trained offline and then trained online, according to aspects of the disclosure. Both the offline and online training can be based on various artificial intelligence (AI) and/or machine learning (ML) algorithms.

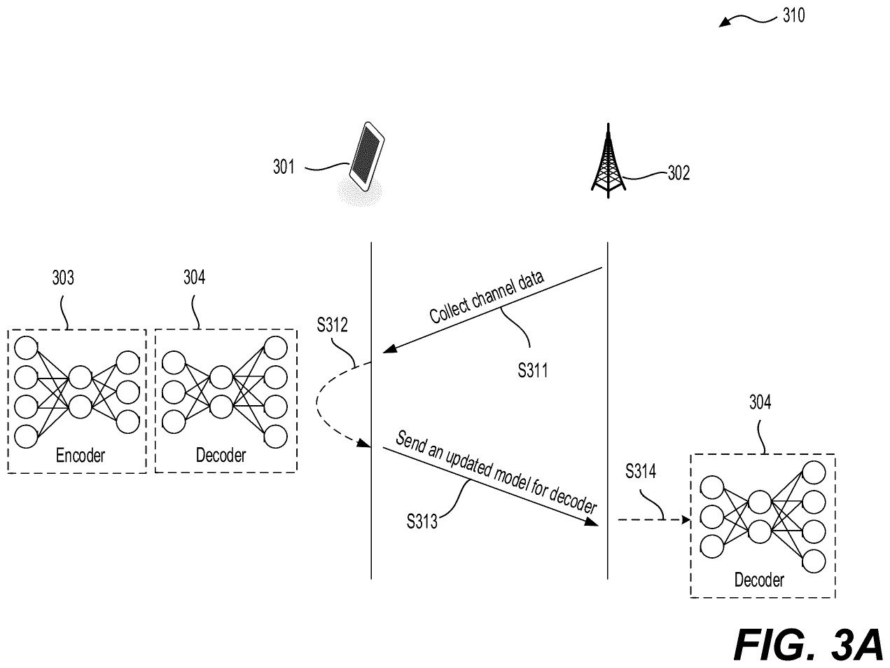

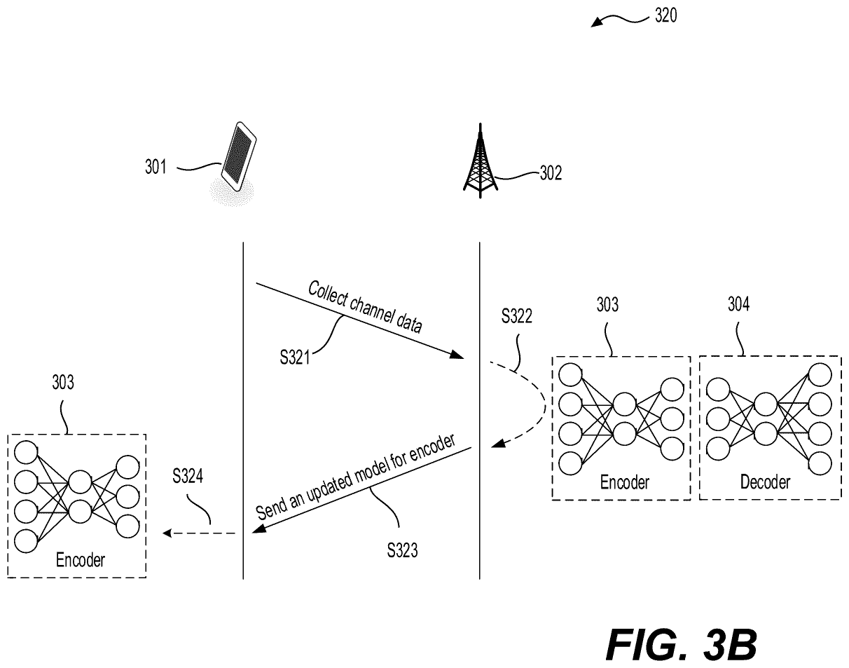

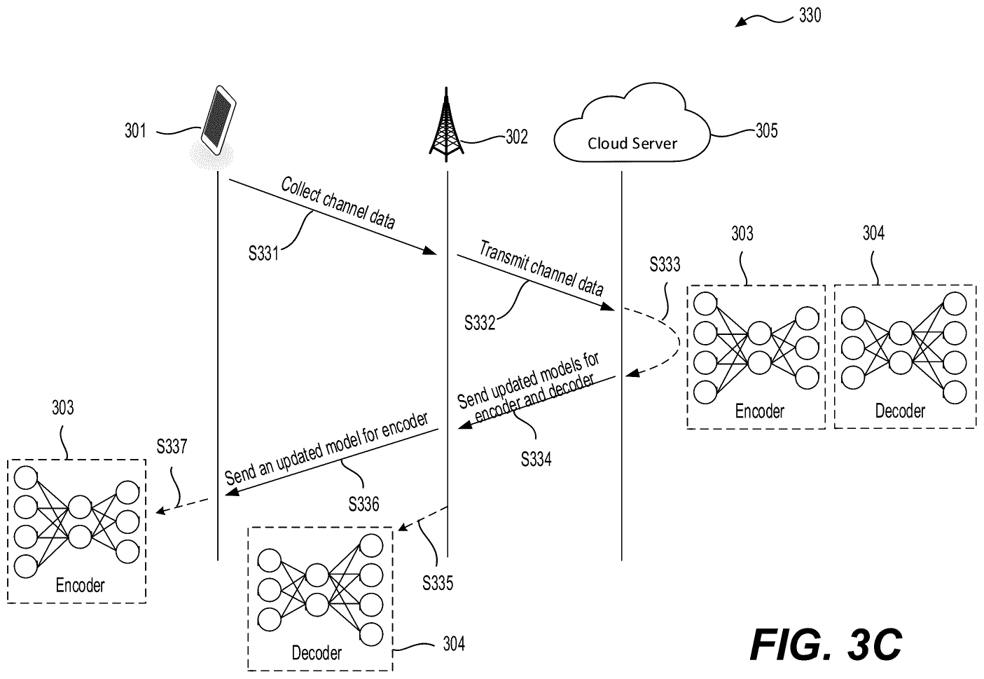

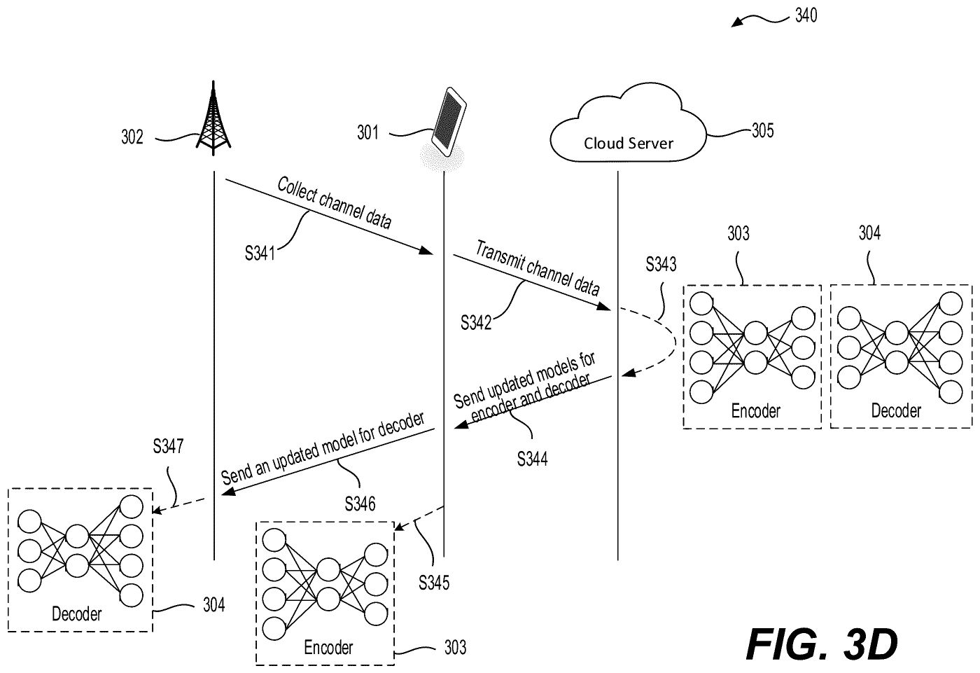

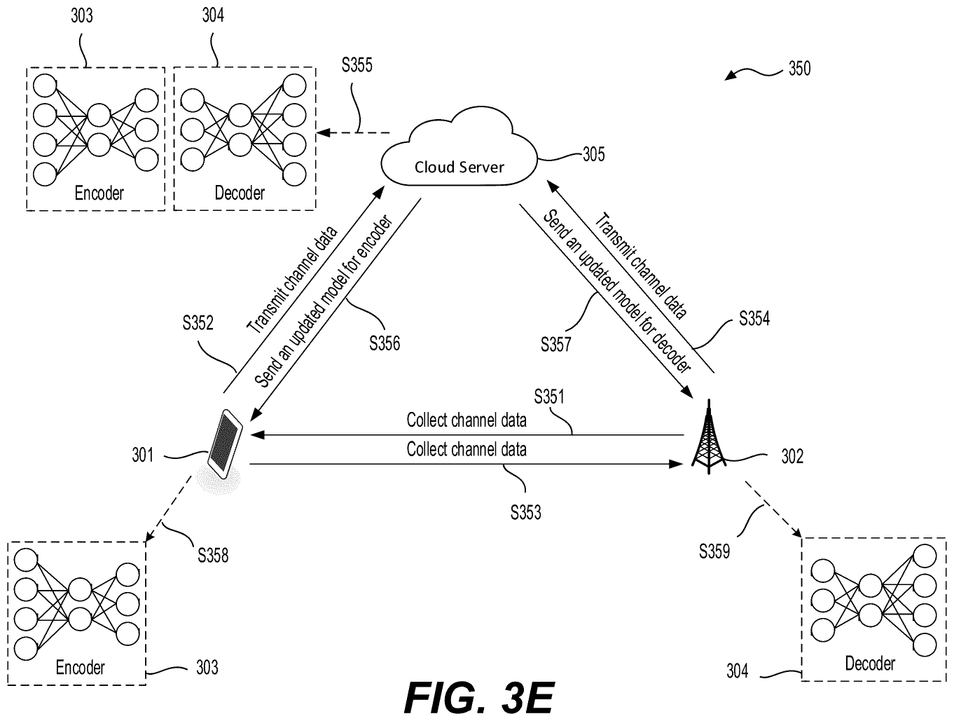

According to aspects of the disclosure, the online training can be performed by a UE, a BS, or a server such as a cloud server. FIGS. 3A-3E show various exemplary procedures of the online training CSI data according to embodiments of the disclosure.

FIG. 3A shows an exemplary procedure 300 of online training CSI data according to embodiments of the disclosure. In the procedure 300, a UE 301 can be configured with a trained encoder model (or compression model) 303 and encode (or compress) raw CSI data into a compressed CSI based on the trained encoder (or compression model) 303. The UE 301 can send the compressed CSI to a BS 302 that is configured with a trained decoder model (or decompression model) 304. The BS 302 can decode (or decompress) the compressed CSI based on the trained decoder model (or decompression model) 304 to reconstruct an estimated CSI.

To perform the online training, the UE 301 can be further configured with an entire encoder-decoder model pair including the encoder model 303 and the decoder model 304. After gathering new CSI data at the UE 301, the UE 301 can perform the online training to train the entire encoder-decoder model pair with the new CSI data. After the online training, the UE 301 can transmit an updated model for the decoder model 304 to the BS 302. Then, the BS 302 can perform the decoding of CSI data based on the updated model for the decoder model 304.

Specifically, at step S310, the UE 301 can collect channel data. For example, the UE 301 can receive a reference signal such as CSI-RS transmitted from the BS 302 and measure the channel data based on the received reference signal.

At step S312, after collecting the channel data, the UE 301 can perform the online training by training the entire encoder-decoder pair based on the collected channel data to obtain an updated model for the encoder model 303 and an updated model for the decoder model 304. For example, through the online training, the UE 301 can obtain updated values for at least partial weights of the encoder-decoder model pair. Then, the UE 301 can update the encoder 303 based on the updated model for the encoder 303. For example, the UE 301 can update the encoder 303 based on the updated values for the at least partial weights of the encoder model 303.

At step S314, the UE 301 can transmit the updated model for the decoder model 304 to the BS 302. For example, the UE 301 can send the updated values for the at least partial weights of the decoder model 304 to the BS 302.

At step S316, the BS 302 can update the decoder model 304 based on the received updated model. For example, the BS 302 can update the decoder model 304 based on the updated values for the at least partial weights of the decoder model 304.

After the online training, the UE 301 can compress a raw CSI based on the updated encoder model 303, and the BS 302 can decompress a compressed CSI based on the updated decoder model 304. Through the online training, the overhead and complexity for compressing CSI can be reduced.

FIG. 3B shows an exemplary procedure 320 of online training CSI data according to embodiments of the disclosure. In the procedure 320, the BS302 can be configured with the entire encoder-decoder model pair including the encoder model 303 and the decoder model 304 and thus perform the online training.

Specifically, at step S330, the BS 302 can collect channel data. In an example such as in TDD (Time Division Duplexing), the BS 302 can use channel reciprocity to collect the channel data. That is, the BS 302 can receive a reference signal such as CSI-RS from the UE 301 and measure the channel data based on the received reference signal. Alternatively, in another example such as in FDD (Frequency Division Duplexing), the UE 301 can measure the channel data and report to the BS 302.

At step S332, after collecting the channel data, the BS 302 can perform the online training by training the entire encoder-decoder model pair based on the collected channel data to obtain an updated model for the encoder model 303 and an updated model for the decoder model 304. For example, through the online training, the BS 302 can obtain updated values for at least partial weights of the encoder-decoder model pair. Then, the BS 302 can update the decoder 304 based on the updated model for the decoder 304. For example, the BS 302 can update the decoder 304 based on the updated values for the at least partial weights of the decoder model 304.

At step S334, the BS 302 can transmit the updated model for the encoder model 303 to the UE 301. For example, the BS 302 can send the updated values for the at least partial weights of the encoder model 303 to the UE 301.

At step S336, the UE 301 can update the encoder model 303 based on the received updated model. For example, the UE 301 can update the encoder model 303 based on the updated values for the at least partial weights of the encoder model 303.

After the online training, the UE 301 can compress a raw CSI based on the updated encoder model 303, and the BS 302 can decompress a compressed CSI based on the updated decoder model 304. Through the online training, the overhead and complexity for compressing CSI can be reduced.

FIG. 3C shows an exemplary procedure 330 of online training CSI data according to embodiments of the disclosure. In the procedure 330, the online training can be performed at a server such as a cloud server 305 that is configured with the entire encoder-decoder model pair including the encoder model 303 and the decoder model 304.

Specifically, at step S331, the BS 302 can collect channel data. In an example such as in TDD, the BS 302 can use channel reciprocity to collect the channel data. That is, the BS 302 can receive a reference signal such as CSI-RS from the UE 301 and measure the channel data based on the received reference signal. Alternatively, in another example such as in FDD, the UE 301 can measure the channel data and report to the BS 302.

At step S332, after collecting the channel data, the BS 302 can transmit the channel data to the cloud server 305.

At step S333, the cloud server 305 can perform the online training by training the entire encoder-decoder model pair based on the collected channel data to obtain an updated model for the encoder model 303 and an updated model for the decoder model 304. For example, through the online training, the cloud server 305 can obtain updated values for at least partial weights of the encoder-decoder model pair.

At step S334, after the entire encoder-decoder model pair has been trained and updated, the cloud server 305 can send updated models for the encoder 303 and the decoder 304 to the BS 302.

At step S335, after receiving the updated models for the encoder 303 and the decoder 304, the BS 302 can update the decoder 304 based on the updated model for the decoder 304. For example, the BS 302 can update the decoder 304 based on the updated values for the at least partial weights of the decoder model 304.

At step S336, the BS 302 can transmit the updated model for the encoder model 303 to the UE 301. For example, the BS 302 can send the updated values for the at least partial weights of the encoder model 303 to the UE 301.

At step S337, the UE 301 can update the encoder model 303 based on the received updated model. For example, the UE 301 can update the encoder model 303 based on the updated values for the at least partial weights of the encoder model 303.

After the online training, the UE 301 can compress a raw CSI based on the updated encoder model 303, and the BS 302 can decompress a compressed CSI based on the updated decoder model 304. Through the online training, the overhead and complexity for compressing CSI can be reduced.

FIG. 3D shows an exemplary procedure 340 of online training CSI data according to embodiments of the disclosure. In the procedure 340, the online training can be performed at a server such as the cloud server 305 that is configured with the entire encoder-decoder model pair including the encoder model 303 and the decoder model 304.

Specifically, at step S341, the UE 301 can collect channel data. For example, the UE 301 can receive a reference signal such as CSI-RS transmitted from the BS 302 and measure the channel data based on the received reference signal.

At step S342, after collecting the channel data, the UE 301 can transmit the channel data to the cloud server 305.

At step S343, the cloud server 305 can perform the online training by training the entire encoder-decoder model pair based on the collected channel data to obtain an updated model for the encoder model 303 and an updated model for the decoder model 304. For example, through the online training, the cloud server 305 can obtain updated values for at least partial weights of the encoder-decoder model pair.

At step S344, after the entire encoder-decoder model pair has been trained and updated, the cloud server 305 can send updated models for the encoder 303 and the decoder 304 to the UE 301.

At step S345, after receiving the updated models for the encoder 303 and the decoder 304, the UE 301 can update the encoder 303 based on the updated model for the encoder 303. For example, the UE 301 can update the encoder 303 based on the updated values for the at least partial weights of the encoder model 303.

At step S346, the UE 301 can transmit the updated model for the decoder model 304 to the BS 302. For example, the UE 301 can send the updated values for the at least partial weights of the decoder model 304 to the BS 302.

At step S347, the BS 302 can update the decoder model 304 based on the received updated model. For example, the BS 302 can update the decoder model 304 based on the updated values for the at least partial weights of the decoder model 304.

After the online training, the UE 301 can compress a raw CSI based on the updated encoder model 303, and the BS 302 can decompress a compressed CSI based on the updated decoder model 304. Through the online training, the overhead and complexity for compressing CSI can be reduced.

In the example of FIG. 3C, the server 305 receives the channel data from the BS 302 and transmits to the BS 302 the updated models for the encoder model 303 and the decoder model 304. Then, the BS 302 transmits to the UE 301 the updated model for the encoder 303.

In the example of FIG. 3D, the server 305 receives the channel data from the UE 301 and transmits to the UE 301 the updated models for the encoder model 303 and the decoder model 304. Then, the UE 301 transmits to the BS 302 the updated model for the decoder 304.

According to aspects of the disclosure, the server 305 can receive the channel data from both the UE 301 and the BS 302, and transmit the updated models for the encoder model 303 and the decoder model 304 to the UE 301 and the BS 302, respectively.

FIG. 3E shows an exemplary procedure 350 of online training CSI data according to embodiments of the disclosure. In the procedure 350, the online training can be performed at a server such as the cloud server 305 that is configured with the entire encoder-decoder model pair including the encoder model 303 and the decoder model 304. Each of the UE 301 and the BS 302 can collect channel data and report to the cloud server 305. For example, the UE 301 can collect the channel data at step S351 and report to the cloud server 305 at step S352. The BS 304 can collect the channel data at step S353 and report to the cloud server 305 at step S354.

After receiving the channel data, the cloud server 305 can perform the online training at step S355 and send the updated models to the UE 301 and the BS 302 at steps S356 and S357, respectively. Then, the UE 301 and the BS 302 can update the encoder model 303 and the decoder model 304 at steps S358 and S359, respectively.

It is noted that whether the cloud server 305 can perform the online training after receiving the channel data from both or one of the UE 301 and the BS 302 is not limited in this disclosure. In an example, after receiving the channel data from both the UE 301 and the BS 302, the cloud server 305 can perform the online training. In an example, after receiving the channel data from any one of the UE 301 and the BS 302, the cloud server 305 can perform the online training.

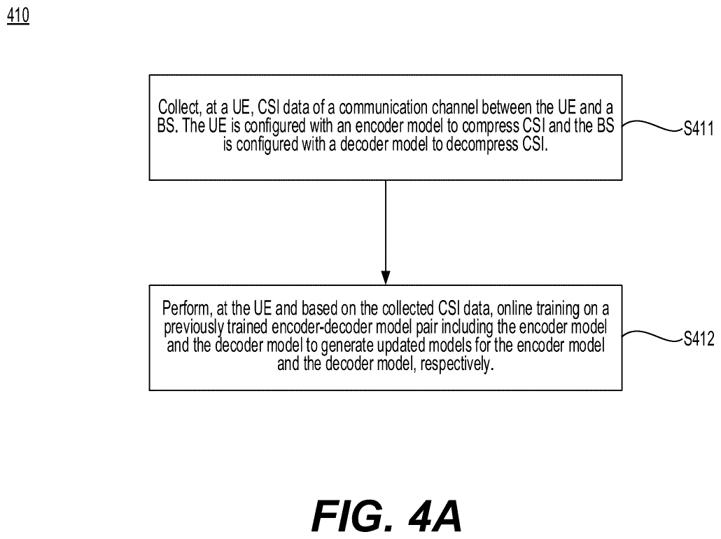

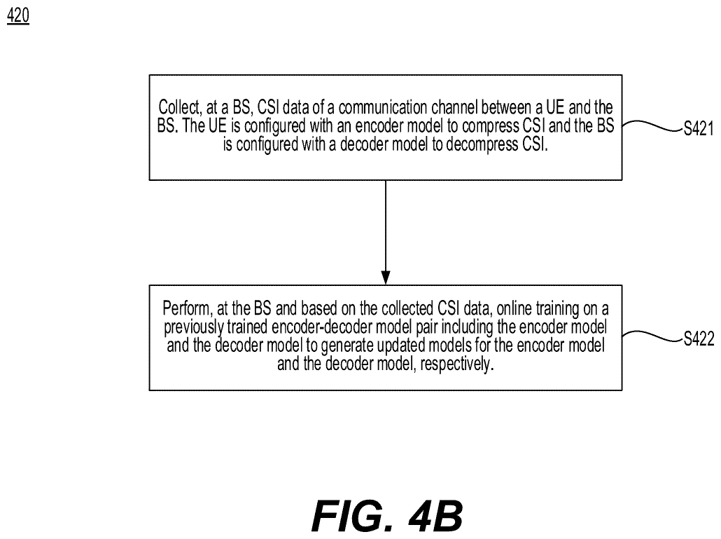

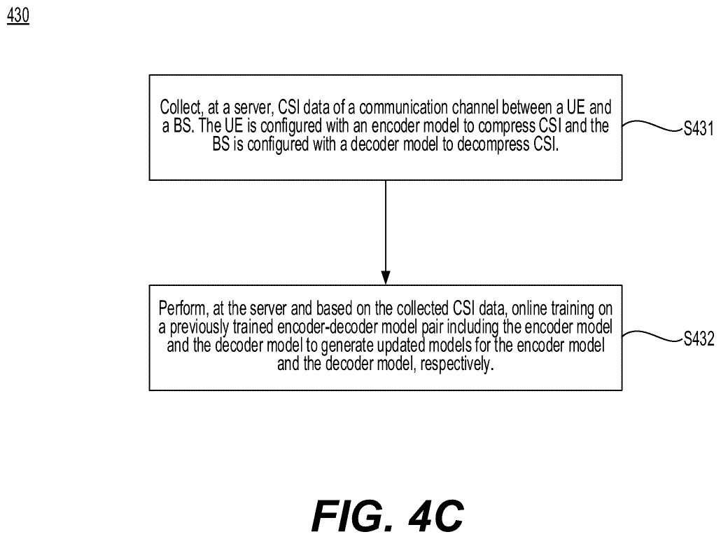

FIG. 4A shows a flowchart outlining a process 410 according to embodiments of the disclosure. The process 410 can be executed by processing circuitry 510 of the apparatus 500. The process 410 can also be executed by at least one of the CPU 641, the GPU 642, the FPGA 643, or the accelerator 644 of the computer system 600. The process 410 can be implemented in software instructions, and when the processing circuitry 510 or the at least one of the CPU 641, the GPU 642, the FPGA 643, or the accelerator 644 executes the software instructions, the processing circuitry 510 or the at least one of the CPU 641, the GPU 642, the FPGA 643, or the accelerator 644 performs the process 410.

The process 410 may generally start at step 411, where the process 410 collects, at a UE, CSI data of a communication channel between the UE and a BS. The UE is configured with an encoder model to compress CSI and the BS is configured with a decoder model to decompress CSI. Then, the process 410 proceeds to step S412.

At step S412, the process 410 performs, at the UE and based on the collected CSI data, online training on a previously trained encoder-decoder model pair including the encoder model and the decoder model to generate updated models for the encoder model and the decoder model, respectively. Then, the process 410 terminates.

In an embodiment, the process 410 sends, from the UE to the BS, the updated model for the decoder model. The updated model for the decoder model sent from UE is used by the BS to update the decoder model of the BS. The process 410 updates, at the UE, the encoder model of the UE based on the updated model for the encoder model. The process 410 compresses, at the UE, a CSI element into a compressed CSI element based on the updated encoder model. The process 410 sends the compressed CSI element from the UE to the BS. The compressed CSI element is decompressed by the BS based on the updated decoder model.

In an embodiment, the updated models include at least partial parameters of the encoder model and the decoder model.

In an embodiment, the process 410 receives, at the UE, a reference signal from the BS, and measures, at the UE, the CSI data based on the reference signal.

FIG. 4B shows a flowchart outlining a process 420 according to embodiments of the disclosure. The process 420 can be executed by processing circuitry 510 of the apparatus 500. The process 420 can also be executed by at least one of the CPU 641, the GPU 642, the FPGA 643, or the accelerator 644 of the computer system 600. The process 420 can be implemented in software instructions, and when the processing circuitry 510 or the at least one of the CPU 641, the GPU 642, the FPGA 643, or the accelerator 644 executes the software instructions, the processing circuitry 510 or the at least one of the CPU 641, the GPU 642, the FPGA 643, or the accelerator 644 performs the process 420.

The process 420 may generally start at step 421, where the process 420 collects, at a BS, CSI data of a communication channel between a UE and the BS. The UE is configured with an encoder model to compress CSI and the BS is configured with a decoder model to decompress CSI. Then, the process 420 proceeds to step S422.

At step S422, the process 420 performs, at the BS and based on the collected CSI data, online training on a previously trained encoder-decoder model pair including the encoder model and the decoder model to generate updated models for the encoder model and the decoder model, respectively. Then, the process 420 terminates.

In an embodiment, the process 420 sends, from the BS to the UE, the updated model for the encoder model. The updated model for the encoder model sent from the BS is used by the UE to update the encoder of the UE. Based on the updated encoder model, a CSI element is compressed by the UE into a compressed CSI element. The compressed CSI element is sent from the UE to the BS. The process 420 updates, at the BS, the decoder model of the BS based on the updated model for the decoder model. The process 420 decompresses, at the BS, the compressed CSI element based on the updated decoder model.

In an embodiment, the updated models include at least partial parameters of the encoder model and the decoder model.

In an embodiment, the process 420 receives, at the BS, a reference signal from the UE, and measures, at the BS, the CSI data based on the reference signal.

In an embodiment, the process 420 sends, from the BS, a reference signal to the UE, and receives, at the BS and from the UE, a CSI report including the CSI data that is generated by the UE based on the reference signal.

FIG. 4C shows a flowchart outlining a process 430 according to embodiments of the disclosure. The process 430 can be executed by processing circuitry 510 of the apparatus 500. The process 430 can also be executed by at least one of the CPU 641, the GPU 642, the FPGA 643, or the accelerator 644 of the computer system 600. The process 430 can be implemented in software instructions, and when the processing circuitry 510 or the at least one of the CPU 641, the GPU 642, the FPGA 643, or the accelerator 644 executes the software instructions, the processing circuitry 510 or the at least one of the CPU 641, the GPU 642, the FPGA 643, or the accelerator 644 performs the process 430.

The process 430 may generally start at step 431, where the process 430 collects, at a server, CSI data of a communication channel between a UE and a BS. The UE is configured with an encoder model to compress CSI and the BS is configured with a decoder model to decompress CSI. Then, the process 430 proceeds to step S432.

At step S432, the process 430 performs, at the server and based on the collected CSI data, online training on a previously trained encoder-decoder model pair including the encoder model and the decoder model to generate updated models for the encoder model and the decoder model, respectively. Then, the process 430 terminates.

In an embodiment, the process 430 sends, from the server to the BS, the updated models for the encoder model and the decoder model. The updated model for the decoder model is used by the BS to update the decoder model of the BS. The updated model for the encoder model is transmitted by the BS to the UE. The updated model for the encoder model transmitted from the BS is used by the UE to update the encoder model of the UE.

In an embodiment, the process 430 sends, from the server to the UE, the updated models for the encoder model and the decoder model. The updated model for the encoder model is used by the UE to update the encoder model of the UE. The updated model for the decoder model is transmitted by the UE to the BS. The updated model for the decoder model transmitted from the UE is used by the BS to update the decoder model of the BS.

In an embodiment, the process 430 sends, from the server to the BS, the updated model for the decoder model, and sends, from the server to the UE, the updated model for the encoder model.

In an embodiment, the process 430 collects, at the server, the CSI data from at least one of the BS and the UE. In an example, the process 430 collects, at the server, the CSI data from the BS or the UE. In an example, the process 430 collects, at the server, the CSI data from both the BS and the UE.

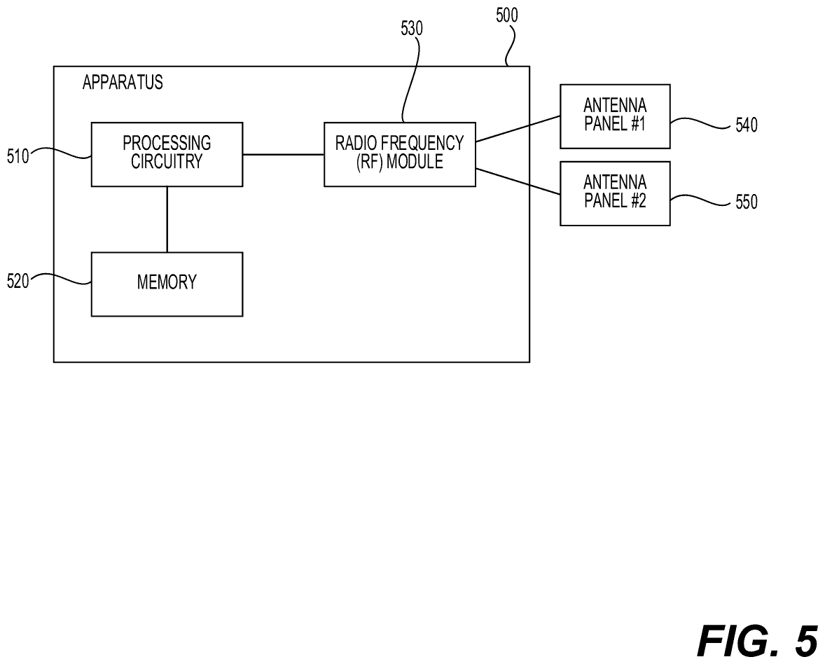

FIG. 5 shows an exemplary apparatus 500 according to embodiments of the disclosure. The apparatus 500 can be configured to perform various functions in accordance with one or more embodiments or examples described herein. Thus, the apparatus 500 can provide means for implementation of techniques, processes, functions, components, systems described herein. For example, the apparatus 500 can be used to implement functions of a UE or a base station (BS) (e.g., gNB) in various embodiments and examples described herein. The apparatus 500 can include a general purpose processor or specially designed circuits to implement various functions, components, or processes described herein in various embodiments. The apparatus 500 can include processing circuitry 510, a memory 520, and a radio frequency (RF) module 530.

In various examples, the processing circuitry 510 can include circuitry configured to perform the functions and processes described herein in combination with software or without software. In various examples, the processing circuitry 510 can be a digital signal processor (DSP), an application specific integrated circuit (ASIC), programmable logic devices (PLDs), field programmable gate arrays (FPGAs), digitally enhanced circuits, or comparable device or a combination thereof.

In some other examples, the processing circuitry 510 can be a central processing unit (CPU) configured to execute program instructions to perform various functions and processes described herein. Accordingly, the memory 520 can be configured to store program instructions. The processing circuitry 510, when executing the program instructions, can perform the functions and processes. The memory 520 can further store other programs or data, such as operating systems, application programs, and the like. The memory 520 can include a read only memory (ROM), a random access memory (RAM), a flash memory, a solid state memory, a hard disk drive, an optical disk drive, and the like.

The RF module 530 receives a processed data signal from the processing circuitry 510 and converts the data signal to beamforming wireless signals that are then transmitted via antenna panels 540 and/or 550, or vice versa. The RF module 530 can include a digital to analog convertor (DAC), an analog to digital converter (ADC), a frequency up convertor, a frequency down converter, filters and amplifiers for reception and transmission operations. The RF module 530 can include multi-antenna circuitry for beamforming operations. For example, the multi-antenna circuitry can include an uplink spatial filter circuit, and a downlink spatial filter circuit for shifting analog signal phases or scaling analog signal amplitudes. Each of the antenna panels 540 and 550 can include one or more antenna arrays.

In an embodiment, part of all the antenna panels 540/550 and part or all functions of the RF module 530 are implemented as one or more TRPs (transmission and reception points), and the remaining functions of the apparatus 500 are implemented as a BS. Accordingly, the TRPs can be co-located with such a BS, or can be deployed away from the BS.

The apparatus 500 can optionally include other components, such as input and output devices, additional or signal processing circuitry, and the like. Accordingly, the apparatus 500 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid-state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

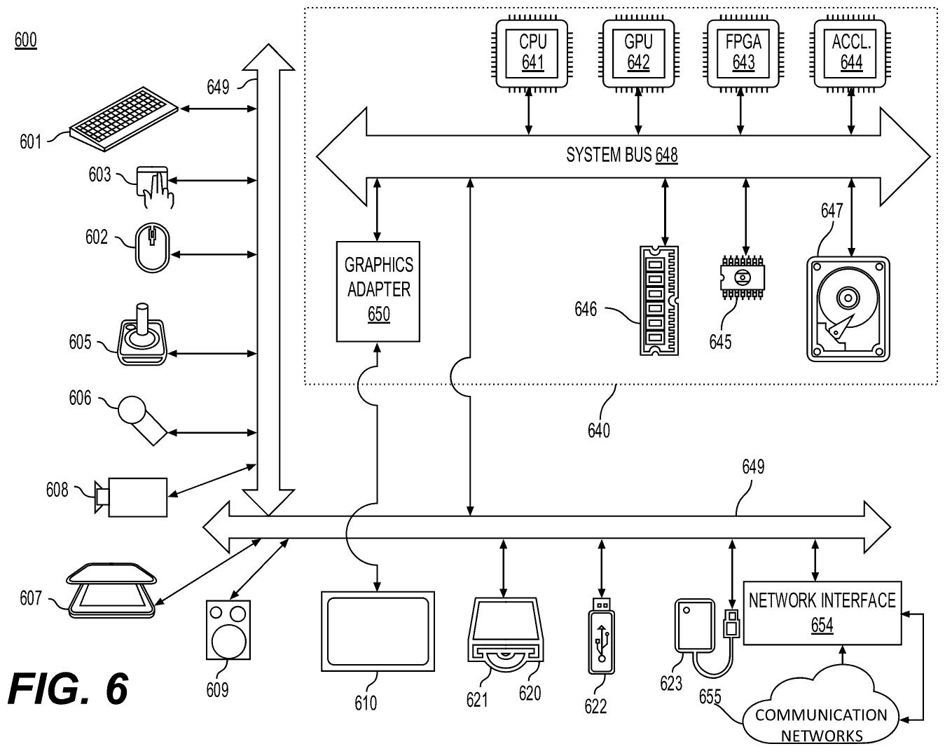

The techniques described above, can be implemented as computer software using computer-readable instructions and physically stored in one or more computer-readable media. For example, FIG. 6 shows a computer system (600) suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 6 for computer system (600) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (600).

Computer system (600) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (601), mouse (602), trackpad (603), touch screen (610), data-glove (not shown), joystick (605), microphone (606), scanner (607), and camera (608).

Computer system (600) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (610), data-glove (not shown), or joystick (605), but there can also be tactile feedback devices that do not serve as input devices), audio output devices (such as: speakers (609), headphones (not depicted)), visual output devices (such as screens (610) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted). These visual output devices (such as screens (610)) can be connected to a system bus (648) through a graphics adapter (650).

Computer system (600) can also include human accessible storage devices and their associated media such as optical media including CD/DVD ROM/RW (620) with CD/DVD or the like media (621), thumb-drive (622), removable hard drive or solid state drive (623), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (600) can also include a network interface (654) to one or more communication networks (655). The one or more communication networks (655) can for example be wireless, wireline, optical. The one or more communication networks (655) can further be local, wide-area, metropolitan, vehicular and industrial, real-time, delay-tolerant, and so on. Examples of the one or more communication networks (655) include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (649) (such as, for example USB ports of the computer system (600)); others are commonly integrated into the core of the computer system (600) by attachment to a system bus as described below (for example Ethernet interface into a PC computer system or cellular network interface into a smartphone computer system). Using any of these networks, computer system (600) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (640) of the computer system (600).

The core (640) can include one or more Central Processing Units (CPU) (641), Graphics Processing Units (GPU) (642), specialized programmable processing units in the form of Field Programmable Gate Areas (FPGA) (643), hardware accelerators (644) for certain tasks, graphics adapters (650), and so forth. These devices, along with Read-only memory (ROM) (645), Random-access memory (646), internal mass storage (647) such as internal non-user accessible hard drives, SSDs, and the like, may be connected through the system bus (648). In some computer systems, the system bus (648) can be accessible in the form of one or more physical plugs to enable extensions by additional CPUs, GPU, and the like. The peripheral devices can be attached either directly to the core's system bus (648), or through a peripheral bus (649). In an example, the screen (610) can be connected to the graphics adapter (650). Architectures for a peripheral bus include PCI, USB, and the like.

CPUs (641), GPUs (642), FPGAs (643), and accelerators (644) can execute certain instructions that, in combination, can make up the aforementioned computer code. That computer code can be stored in ROM (645) or RAM (646). Transitional data can be also be stored in RAM (646), whereas permanent data can be stored for example, in the internal mass storage (647). Fast storage and retrieve to any of the memory devices can be enabled through the use of cache memory, that can be closely associated with one or more CPU (641), GPU (642), mass storage (647), ROM (645), RAM (646), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (600), and specifically the core (640) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (640) that are of non-transitory nature, such as core-internal mass storage (647) or ROM (645). The software implementing various embodiments of the present disclosure can be stored in such devices and executed by core (640). A computer-readable medium can include one or more memory devices or chips, according to particular needs. The software can cause the core (640) and specifically the processors therein (including CPU, GPU, FPGA, and the like) to execute particular processes or particular parts of particular processes described herein, including defining data structures stored in RAM (646) and modifying such data structures according to the processes defined by the software. In addition or as an alternative, the computer system can provide functionality as a result of logic hardwired or otherwise embodied in a circuit (for example: accelerator (644)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method for channel state information (CSI) feedback, the method comprising:
collecting, at a user equipment (UE), CSI data of a communication channel between the UE and a base station (BS), wherein the UE is configured with an encoder model to compress CSI and the BS is configured with a decoder model to decompress CSI; and
performing, at the UE and based on the collected CSI data, online training on a previously trained encoder-decoder model pair including the encoder model and the decoder model to generate updated models for the encoder model and the decoder model, respectively.

2. The method of claim 1, further comprising:
sending, from the UE to the BS, the updated model for the decoder model;
updating, at the UE, the encoder model of the UE based on the updated model for the encoder model; and
compressing, at the UE, a CSI element into a compressed CSI element based on the updated encoder model.

3. The method of claim 2, wherein the decoder model of the BS is updated based on the updated model for the decoder model sent from the UE, and wherein the compressed CSI element is decompressed by the BS based on the updated decoder model.

4. The method of claim 1, wherein the updated models include at least partial parameters of the encoder model and the decoder model.

5. The method of claim 1, wherein the collecting includes:
receiving, at the UE, a reference signal from the BS; and
measuring, at the UE, the CSI data based on the reference signal.

6. A method for channel state information (CSI) feedback, the method comprising:
collecting, at a base station (BS), CSI data of a communication channel between the BS and a user equipment (UE), wherein the UE is configured with an encoder model to compress CSI and the BS is configured with a decoder model to decompress CSI; and
performing, at the BS and based on the collected CSI data, online training on a previously trained encoder-decoder model pair including the encoder model and the decoder model to generate updated models for the encoder model and the decoder model, respectively.

7. The method of claim 6, further comprising:
sending, from the BS to the UE, the updated model for the encoder model;
updating, at the BS, the decoder model of the BS based on the updated model for the decoder model; and
decompressing, at the BS, a compressed CSI element based on the updated decoder model.

8. The method of claim 7, wherein the encoder model of the UE is updated based on the updated model for the encoder model sent from the BS, and wherein the compressed CSI element is generated by the UE based on the updated encoder model.

9. The method of claim 6, wherein the updated models include at least partial parameters of the encoder model and the decoder model.

10. The method of claim 6, wherein the collecting includes:
receiving, at the BS, a reference signal from the UE; and
measuring, at the BS, the CSI data based on the reference signal.

11. The method of claim 6, wherein the collecting includes:
sending, from the BS, a reference signal to the UE;
receiving, at the BS and from the UE, a CSI report including the CSI data that is generated by the UE based on the reference signal.

12. A method for channel state information (CSI) feedback, the method comprising:
collecting, at a server, CSI data of a communication channel between a user equipment (UE) and a base station (BS), wherein the UE is configured with an encoder model to compress CSI and the BS is configured with a decoder model to decompress CSI; and
performing, at the server and based on the collected CSI data, online training on a previously trained encoder-decoder model pair including the encoder model and the decoder model to generate updated models for the encoder and the decoder, respectively.

13. The method of claim 12, further comprising:
sending, from the server to the BS, the updated models for the encoder model and the decoder model.

14. The method of claim 13, wherein the updated model for the decoder model sent from the server is used by the BS to update the decoder of the BS, and the updated model for the encoder model sent from the server is transmitted by the BS to the UE.

15. The method of claim 14, wherein the updated model for the encoder model transmitted from the BS is used by the UE to update the encoder model of the UE.

16. The method of claim 12, further comprising:
sending, from the server to the UE, the updated models for the encoder model and the decoder model.

17. The method of claim 16, wherein the updated model for the encoder model sent from the server is used by the UE to update the encoder model of the UE, and the updated model for the decoder model sent from the server is transmitted by UE to the BS.

18. The method of claim 17, wherein the updated model for the decoder model transmitted from the UE is used by the BS to update the decoder model of the BS.

19. The method of claim 12, further comprising:
sending, from the server to the BS, the updated model for the decoder model; and
sending, from the server to the UE, the updated model for the encoder model.

20. The method of claim 12, wherein the collecting includes:
collecting, at the server, the CSI data from at least one of the BS and the UE.
